(19) United States
(12) Patent Application Publication
(10) Pub. No.: US 2007/0040679 A1
(43) Pub. Date: Feb. 22, 2007

(54) Decorative Transponder Cover

(76) Inventor: James Klosinski, Lindenhurst, IL (US)

Correspondence Address: PIONEER PATENT, LLC, P. O. BOX 128, NORTHBROOK, IL, 60065-0128, US

(21) Appl. No.: 11/161,923

(22) Filed: Aug. 22, 2005

(51) Int. Cl. G08B 13/14

(52) U.S. Cl. 340/572.1

(57) ABSTRACT

A decorative cover for a tollway transponder is disclosed that comprises an external display surface attached at a rear edge to an internal surface, where the internal surface defines a volume capable of housing said transponder. The decorative transponder cover can stick, clip or snap onto the transponder in a permanent or removable manner. The decorative transponder can match or complement the automotive interior upholstery, or it can be a fanciful decoration, including being molded into character shapes, or it can have a pocket for the display or holding of an item.

The present invention relates generally to motor vehicle transponders, and particularly to decorative covers thereof. A decorative cover for a transponder is disclosed.

### BACKGROUND OF THE INVENTION

Wireless information exchange technology has led to the development of radio frequency (RF) transponders for the electronic payment of fees at toll booths in the United States. Several units have been developed that are typically mounted on the dashboard or windshield of a car. The RFtechnology has limited power to transmit through materials, for example through glass and most plastics. The transmission range depends on power and distance from the transmission source and the intervening materials, but typically extends no more than 50 feet for tollway transponders. Metal and some polymeric materials interfere with the transmission of the RF signals. With variation in the car model, toll booth reader, the in-car transponder and their designs, in many cases, the transponder will not work when it is sitting in or mounted inside of the glove compartment (or other in-car storage compartment).

Several toll transponder models already have means for fastening the transponder to the interior passenger compartment of a vehicle. For example, in 2005 in Illinois a 3″×4″×1″ box-like transponder is attached to the windshield by friction-grip fasteners (similar to VELCRO^{R}). The two interacting releasably-gripping portions of the friction-grip fasteners are bound by a strongly binding adhesive to (i) the car interior and (ii) the transponder, respectively. The transponder can then be attached using the friction-grip to the fastener, typically mounted on the windshield, dashboard, or door panel.

Bryzski, U.S. Pat. No. 6,745,925 B2, issued Jun. 8, 2004 (underlying application published as US 2003/0034368 A1 on Feb. 20, 2003), discloses an enclosed case for a toll transponder formed of a flexible material that has side walls, front and rear walls, a bottom wall, and a folding cover. The cover folds so that an extended portion of the rear wall folds over the open top of the case to enclose the transponder (envelope-like as shown in FIGS. 1 and 2 therein. The case has fastening means connected to the back wall for fastening the case to the windshield of the vehicle.

De Vito, U.S. Pat. No. 5,960,572 issued Oct. 5, 1999, discloses a toll pass holder that is a housing mounted on the windshield with suction cups, into which the transponder is inserted. The housing has an open top to permit the insertion of the transponder. In an embodiment, springs are provided in the housing to hold the pass securely inside. Also disclosed is a clip for the outside of the housing for clipping papers or other thin items (e.g. money, toll tickets, photos, passcards, driver's license).

Friedman, U.S. Pat. No. 6,127,938 issued Oct. 3, 2000, discloses an adjustable shield for a vehicle-mounted toll collection identifier. The holder has a manually actuated shielding portion, so that the vehicle operator can slide the transponder out of the shielding when it is desired to permit communication between the signal of the vehicle-identifying transponder and an externally located interrogator that ascertains the presence of the vehicle. The design shown in FIGS. 2-10 and 11-14 is like a drawer in which the transponder is fastened that can be slid in or out of the shielded area; in FIGS. 9-10 and 15-16 is a flip-down model for either flipping the shielding up or flipping the transponder out to expose the transponder.

The art also discloses several in-car holders for various items, including tissues (Wu, U.S. Pat. No. 6,196,435 B1, issued Mar. 6, 2001), disposable gloves (Novak, U.S. Pat. No. 5,190,197, issued Mar. 2, 1993), business cards (Pitts, U.S. Pat. No. 1,739,801 issued Dec. 17, 1929; Johnson, U.S. Design Pat. No. D397,367 issued Aug. 25, 1998; Morris, U.S. Pat. No. 5,850,057 issued Dec. 22, 1998; Goodfellow, U.S. Pat. No. 6,105,294 issued Aug. 22, 2000), document displays (Shevin, U.S. Pat. No. 4,069,606 issued Jan. 24, 1978; and Barcom, U.S. Design Pat. No. D303,403 issued Sep. 12, 1989) and drink or other article holders (Bowman, U.S. Pat. No. 2,698,155 issued Dec. 28, 1954; Hill, et al. U.S. Pat. No. 4,957,254 issued Sep. 18, 1990).

### BRIEF DESCRIPTION OF THE DRAWINGS

FIG. 1 shows an elevated view of a basic rectangular-shaped, flat-faced snap-on tollway transponder cover having two friction-grip clips (4) on the rear edge (3) of the cover. The exterior (1) and interior (2) surfaces are indicated.

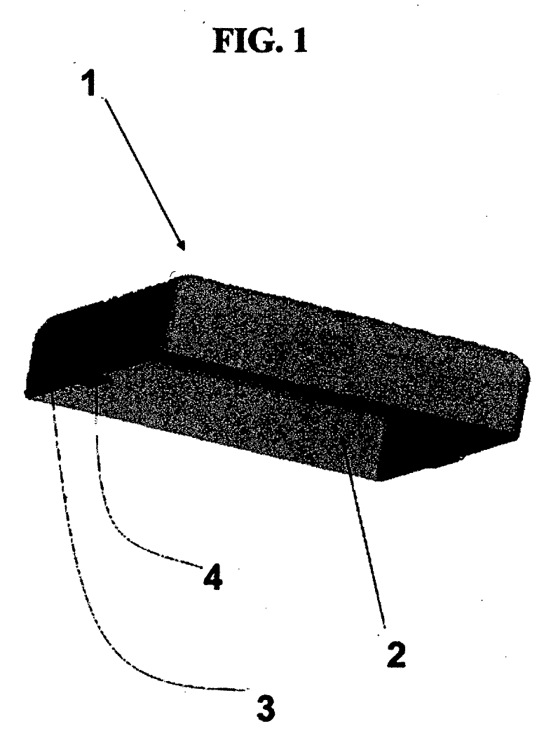

FIG. 2 shows an elevated view of a basic rectangular-shaped, arched-faced snap-on tollway transponder cover having two flaps (4) that can act as friction-grip clips on the rear edge (3) of the cover. The exterior (1) and interior (2) surfaces are indicated.

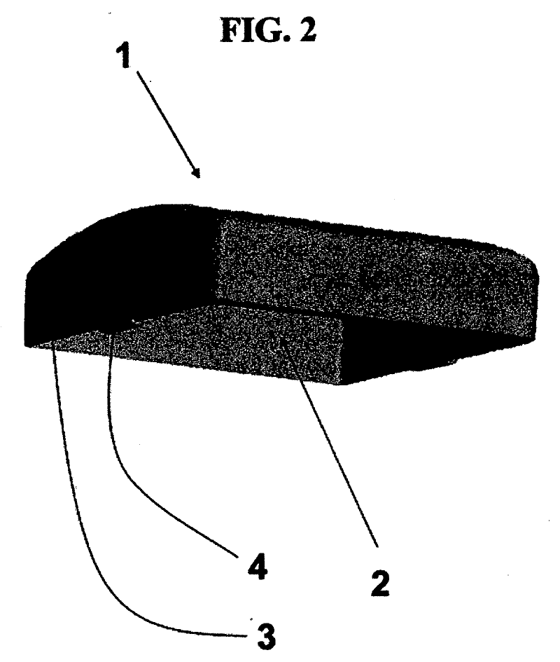

FIG. 3 shows an elevated view of a basic rectangular-shaped, arched-faced clip-on tollway transponder cover having a single clip (4) attached to the rear edge (3) of the cover, where the clip slides behind the body of the transponder to attach the cover to the transponder. The exterior (1) and interior (2) surfaces are indicated.

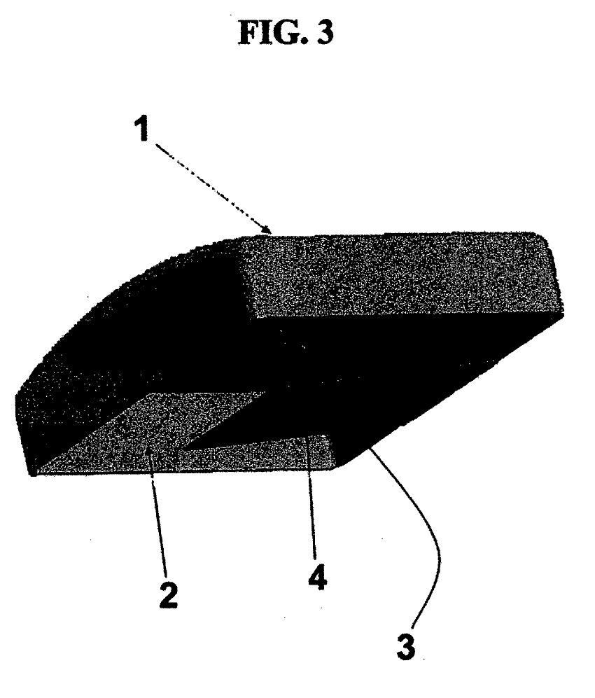

FIG. 4 shows an exploded view of a basic rectangular-shaped, flat-faced stick-on tollway transponder cover having an adhesive material (5) between the cover and the transponder (7). In this case, two layers of adhesive material are shown, for example interacting layers of removable friction-grip material (such as VELCRO®). The exterior (1) and interior (2) surfaces are indicated. A stick-on support (6) is snapped onto the transponder via clips (4), and the stick-on support (6) is bonded to one of the adhesive layers (5). The other adhesive layer is bonded to the interior surface (2) of the decorative cover.

### SUMMARY OF THE INVENTION

The present invention provides for decorative covers for transponders that do not interfere with the necessary transmission of data, signals and information that permit the driver to adapt the transponder to his own style and in some cases, also to practical use. Such practical use may include a display area such as a document holder, clock and/or thermometer display, or a fragrance (such as an air freshener)

A decorative cover for a transponder has an external display surface (1) and an internal surface (2). The external surface is the outside portion of the decorative cover, which is visible when the cover is installed on a transponder. Because the transponders are typically three-dimensional, the internal surface of the transponder cover defines a volume capable of housing the transponder. Typically a transponder has a maximum thickness (depth) ranging from four millimeters to more than a centimeter, most typically less than two centimeters. The internal surface of the decorative transponder cover is not typically a display surface. In many embodiments, the internal surface is essentially form-fitting to the transponder to be covered. The external surface of the decorative cover connects to the internal surface at a rear edge of cover. The “rear” is the part closest to the surface upon which the transponder is attached or placed.

A contemplated decorative cover does not serve as the means for attachment of the transponder to the motor vehicle. Rather, the transponder being covered typically is already attached to the motor vehicle or is unattached. The decorative cover encases the transponder, but not completely. An opening remains for insertion and removal of the transponder, the cover being slid on, clipped on, or snapped on over the transponder. As such, the front surface of the transponder faces toward the internal surface of the decorative cover, and the rear surface of the transponder faces out the rear of the decorative cover when installed in the clip-on and snap-on embodiments. The opening is optionally at a lower edge of the decorative cover in a slide-on embodiment. Typically, one or more openings are in the rear of the decorative cover so that the decorative cover does not interfere with the means for attaching the transponder to the motor vehicle.

The three-dimensional shape defined by the internal surface of the decorative cover typically reflects the shape of the transponder being covered. A transponder always has a front surface that faces the interior surface of the decorative cover when installed, but the front surface of the transponder may flow smoothly to the rear of the transponder without defined sides. The front surface of the transponder maybe a continuous curve (e.g. circle or oval or other curve) or a polygon. There may be sides extending from a flat or curved front surface of the transponder to the rear of the transponder. Typically, a decorative cover will cover the entire front surface and at least some of the sides (when present) so that the decorative cover can attach at a rear edge. As noted above, all of the edges do not have to be covered by the decorative cover, but the decorative cover needs to be able to be stuck, clipped, snapped or slid on.

In a preferred embodiment of the present invention, a non-shielding material is used for construction of the decorative transponder cover, so as not to interfere with the operation of the transponder. Typical transponders transmit and/or receive in the radio frequency region of the electromagnetic spectrum. Metal shields the transponder transmissions. Certain kinds of plastic materials also have shielding properties, such as those disclosed in U.S. Pat. No. 4,312,917 and Re 32772, and thus should also be avoided in construction of a decorative transponder cover according to this embodiment of the present invention.

As noted herein, the decorative cover does not form the means for attachment of the transponder to the motor vehicle. In typical embodiments, the transponder has a means for adhering to a surface in the motor vehicle, such as one or more strongly adhesive strips on the rear of the transponder. The present invention contemplates the use of a decorative cover in accordance with the invention described herein where the surface to which the transponder attaches has been separately decoratively modified. For example, a decorative decal is placed upon the windshield of a motor vehicle. The transponder is adhered to the decorative decal. Then, a decorative cover according to the present invention is used on a transponder that is mounted on the pre-prepared surface.

Although less preferred, the present invention can also be practiced with a selectively shielding transponder cover as described in U.S. Pat. No. 6,127,938, discussed above. In this embodiment, a decorative cover according to the present invention is attached over the cover according to the U.S. Pat. No. 6,127,938 patent in a manner that still permits the manual actuation of the transponder. For example, in an embodiment wherein a drawer-type compartment houses the transponder and is slid out of the shield for actuation; the decorative cover according to the present invention attaches to the transponder cover out of which the drawer-type compartment slides without impeding or interfering with the sliding motion.

The invention contemplates the use of any of a variety of materials for fabricating a decorative transponder cover, such as plastics, rubbers, acrylics, leathers and artificial leathers, suedes and artificial suedes, fabrics, including those that match with, coordinate with or complement the auto interior upholstery.

The decorative transponder cover includes a means for attaching the cover to a transponder. Contemplated means for attaching the cover include means permitting a clip-on cover, a snap-on cover, a slide-on cover and a stick-on cover. Means for attaching a stick-on cover include double-sided tape, thick foam double-sided tape, adhesives (including glues, pastes and other adhesives), friction-grip interacting tapes (e.g. VELCRO™). Magnetic means are not preferred.

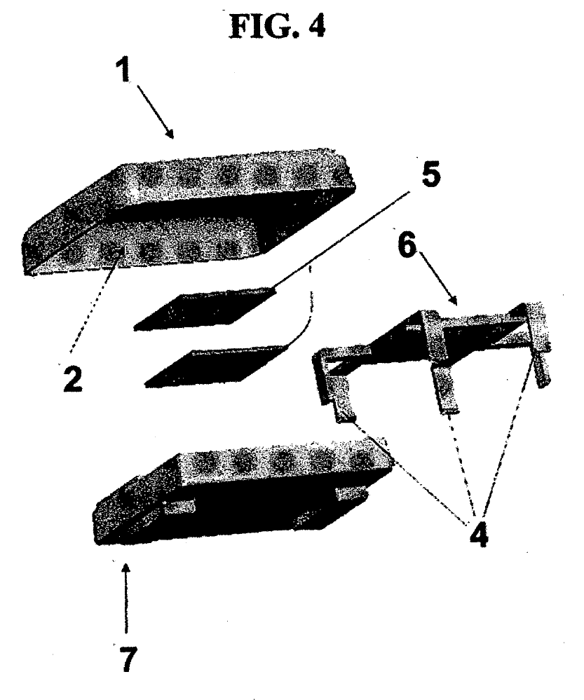

Means for attaching a stick-on cover also includes indirect means, such as that shown in FIG. 4, where a stick-on support (6) is clipped onto the transponder rear edge using flaps (4), and one of two interacting tapes (5) is bonded to the stick-on support (preferably permanently) and the other of the pair of interacting tapes (5) is bonded to the interior surface (2) of the decorative transponder cover (also preferably permanently bonded). In the embodiment shown in FIG. 4, the transponders can easily be swapped out of the decorative transponder cover by unclipping the stick-on support (6) and inserting a new transponder; equivalently, this setup easily permits the swapping of decorative transponder covers by clipping a new cover onto the stick-on support (6).

Other contemplated means for attaching the cover include those of a snap-on or clip-on attachment. In a preferred embodiment, a contemplated decorative transponder cover snaps onto or clips over the existing transponder or other transponder cover. To permit the snapping on or clipping on of the decorative transponder cover according to the present invention, a contemplated decorative transponder cover is constructed with a portion that extends from the rear edge of the decorative cover to partially behind the transponder. In a snap-on cover embodiment, a portion that extends from the rear edge is a ridge or lip, called a flap herein. In a clip-on cover embodiment, a portion that extends from the rear edge is also called a flap herein, although it may be fairly rigid. Following standard patent practice, in the patent claim language, the indefinite article “a” is intended to mean “one or more”, unless a single one is specified.

For a slide-on embodiment, flaps may extend along the rear of the transponder, even the full length, yet not interfere with the direct attachment of the transponder to the motor vehicle. Typically, an opening will be at the lower edge of the decorative cover to permit the sliding on or off of the cover from the transponder.

The portion of the decorative cover that extends behind the transponder extends as a small flap in a snap-on embodiment, such that the flap extends less than ten percent of the way down the length of the transponder in the direction that the flap is extending, preferably less than five percent of the length. Thus, in a snap-on embodiment, the flap is short enough to snap on over the transponder, but long enough to hold the decorative cover on over the transponder. Such a flap in a clip-on embodiment extends from a rear edge of the decorative transponder cover on at least one of the edges, the flap preferably extending more than ten percent of the way down the length of the transponder in the direction that the flap is extending. Thus, in a clip-on embodiment, the flap is long enough to hold the decorative cover on over the transponder.

In a snap-on embodiment where the transponder being covered is a rectangular cube, a flap preferably extends from at least two of the edges. Also contemplated, particularly for a four-edged snap-on embodiment, is a flap extending from all four of the edges. Also contemplated is a single continuous lip extending from two or more of the edges of a multi-edged transponder.

For both snap-on and clip-on embodiments, multiple flaps extending from the same edge of the cover are also contemplated. For a rounded transponder shape, the rear edge of the transponder cover may be a single, continuous edge, and the invention contemplates a lip extending the full length of the edge, or multiple flaps extended from along different portions of the edge.

The portion of the decorative cover that extends from the rear edge of the decorative cover extends as a long flap in a clip-on embodiment. When the decorative transponder cover is clipped onto the transponder, the flap extends behind the back of the transponder. The flap extends more than ten percent, preferably more than thirty percent of the way down the length of the transponder face over which it clips. The flap could extend the full length (e.g. in a slide-on version), but is preferably less than eighty percent of the length for a typical clip-on embodiment, most preferably at least thirty percent. Preferably such a clip is positioned in such a manner that it does not interfere with the means for attachment of the transponder to the passenger compartment interior. The invention contemplates the use of one of more such clips to clip on a single decorative cover.

The decorative transponder cover has an external display surface and a means for attaching the external display surface over the transponder. In a typical embodiment, a decorative transponder cover, the decorative cover has an internal surface that defines a volume capable of housing the transponder, where that volume has a shape that is just slightly larger than the transponder over which the decorative cover is designed to attach.

In order to use some of the less structurally rigid materials—such as leathers, suedes and fabrics—for the decorative external surface of the decorative cover, these materials are preferably firmly attached to, and form-fitted over a snap on or clip on supporting ring or over a fully-formed cover base made of a more rigid, non-shielding material.

In one embodiment, a decorative transponder cover is manufactured using methods common in the art for articles made from a thermosetting liquid monomer, such as urethane or unsaturated polyester (for example, cyclopentadiene). The liquid monomer may additionally include compounds to provide additional material properties, such as short chopped fiberglass for strength, softness and flexibility with silicone, static reducing compounds, electrostatic finish application, fillers such as calcium carbonate. The liquid may be pigmented to produce an article having a foundation color throughout of the desired final color or colors, such that damage to the exterior would not have a color change when scratched, cut or dented. Fabrication is also contemplated using materials that set or are otherwise cured can be carried out using method known in the art, including rotational molding and poured molding (rotational molding preferred for thermoset polymers).

In a preferred version of this embodiment of the invention, the decorative cover is molded in one piece and is slightly flexible, to easily enable slipping the cover over the transponder and snapping into place. In an example of this embodiment, a decorative cover has a large face that faces inward to the passenger compartment of the automobile when it is on the transponder, and walls that extend back from the face to cover the sides of the transponder (four sides joined at the corners if the transponder is a square or rectangular shape, one continuous side if the transponder is a round or oval shape). The wall has (or walls have) an edge that attaches to the large face of the decorative cover, and an edge on the other side of the wall that has a lip or flap that forms a friction grip with the edge of the transponder when it is snapped into place covering the transponder.

The shape of the outside can be widely varied according to the desired decoration, and may be as whimsical as the artist designing the decorative cover desires. For example, the decorative cover may be molded with an outer surface corresponding to sports equipment, such as any number of sports balls (baseball, football, soccer ball, etc.; which may be imprinted with a team name or logo). As further example, the decorative cover may be in the shape of or have the design upon it of a star, sun, planet, car or truck, airplane, animal, team mascot, letters or numbers. In a preferred embodiment using a thermosetting polymer, the decorative cover has an interior surface that essentially conforms to the shape of the tollway transponder being covered.

The decorative cover can also provide a further utility in addition to decoration. It can provide a display surface for a wide variety of items. Contemplated items include documents, photographs, drawings, cards, compact discs, clocks, alarm clocks, thermometers, hygrometers, calculators, radios, music players, telephone numbers, note pads, air fresheners or fragrance pads. Thus a decorative cover could further include a clear or opaque pocket, or the permanent attachment of an item such as described.

It should be appreciated that embodiments of the present invention not specifically described in the detailed examples above do fall within the scope of the invention claimed below.

What is claimed is:

1. A decorative cover for a transponder that comprises an external display surface attached at a rear edge to an internal surface, wherein said internal surface defines a volume capable of housing but not completely enclosing said transponder, said decorative cover further comprising a means for attaching the decorative cover over the transponder.

2. The decorative cover according to claim 1 wherein said means for attaching the decorative cover over the transponder comprises a flap extending from the rear edge of the decorative cover.

3. The decorative cover according to claim 2 wherein said flap extends at least ten percent of the full length of the volume defined by the internal surface in the direction that the flap extends.

4. The decorative cover according to claim 2 wherein said means for attaching the decorative cover over the transponder comprises a small flap less than ten percent of the full length of the volume defined by the internal surface in the direction that the flap extends.

5. The decorative cover according to claim 1 wherein said transponder has a front surface that faces the internal surface of the decorative cover and wherein said means for attaching the decorative cover over the transponder comprises at least one adhesive layer that makes a bond between the internal face of the decorative cover and the front surface of the transponder.

6. The decorative cover according to claim 5 wherein said means for attaching the external display surface over the transponder comprises two adhesive layers which releasably engage with one another wherein the first adhesive layer is bonded strongly to the front surface of the transponder and the second adhesive layer is bonded strongly to the internal surface of the decorative cover.

7. The decorative cover according to claim 1 wherein said means for attaching the decorative cover is an indirect attachment comprising a stick-on support having a small flap less than ten percent of the full length of the volume defined by the internal surface in the direction that the flap extends as long as the transponder side to which it is parallel, thereby making said flap short enough to snap on over the transponder, but long enough to hold the stick-on support on over the transponder, whereby said stick-on support connects via at least one adhesive layer to the internal surface of the decorative cover.

8. The decorative cover according to claim 1 wherein said external display surface comprises a pocket.

9. The decorative cover according to claim 8 wherein said pocket is a clear pocket.

10. The decorative cover according to claim 8 wherein said pocket is an opaque pocket.

11. The decorative cover according to claim 1 wherein said external display surface has molded-in color.

12. The decorative cover according to claim 1 that is a slide-on cover for a rectangular transponder wherein said external display surface comprises a face wall and three side walls having a long edge and two shorter edges, wherein the long edge forms a long corner edge with the face wall and a short edge forms a short corner edge.

13. The decorative cover according to claim 12 wherein said means for attaching the decorative cover over the transponder comprises a flap protruding from each of the two shorter edges.

14. The decorative cover according to claim 1 wherein said decorative cover further comprises a clock.

15. The decorative cover according to claim 1 wherein said decorative cover further comprises a fragrance.
